(19) United States
(12) Patent Application Publication
(10) Pub. No.: US 2011/0305962 A1
(43) Pub. Date: Dec. 15, 2011

(54) FUEL FLEXIBILITY CONFIGURATION IN HIGH TEMPERATURE FUEL CELL SYSTEMS

(75) Inventors: Tero HOTTINEN, Lohja (FI); Kim Åström, Kirkkonummi (FI); Timo Kivisaari, Helsinki (FI)

(73) Assignee: WARTSILA FINLAND OY, Vaasa (FI)

(21) Appl. No.: 13/219,310

(22) Filed: Aug. 26, 2011

Related U.S. Application Data
(63) Continuation of application No. PCT/FI2010/050117, filed on Feb. 22, 2010.

(30) Foreign Application Priority Data
Feb. 26, 2009 (FI) 20095190

(51) Int. Cl. H01M 8/06

(52) U.S. Cl. 429/427

(57) ABSTRACT

A method is disclosed for producing electricity in high temperature fuel cell systems. Gas is circulated at anode sides of the fuel cells. A gas composition at anode sides is determined for providing composition information, and desired temperature conditions are arranged for producing electricity with fuel cells. Rated power of the fuel cell system is controlled by an auxiliary water feed to the fuel cell system by utilizing the composition information, by performing controlled gas recirculation at anode sides by utilizing the composition information by changing the gas recirculation, when a desire arises, and by performing controlled gas feed in to the fuel cell system by utilizing the composition information by changing the gas feed, when a need arises, to change the rated power of the fuel cell system to keep electricity production conditions substantially optimal for the gas used as fuel in the high temperature fuel cell system.

### RELATED APPLICATIONS

This application claims priority as a continuation application under 35 U.S.C. §120 to PCT/FI2010/050117, which was filed as an International Application on Feb. 22, 2010 designating the U.S., and which claims priority to Finnish Application 20095190 filed in Finland on Feb. 26, 2009. The entire contents of these applications are hereby incorporated by reference in their entireties.

### FIELD

Most of the energy of the world is produced by means of oil, coal, natural gas or nuclear power. All these production methods have their specific problems as far as, for example, availability and friendliness to environment are concerned. As far as the environment is concerned, especially oil and coal can cause pollution when they are combusted. A problem with nuclear power is, at least, storage of used fuel.

Because of environmental problems, new energy sources, more environmentally friendly and, for example, having better efficiency than the above-mentioned energy sources, have been developed. Fuel cell devices are a energy conversion device by means of which fuel, for example biogas, is transformed to electricity via a chemical reaction in an environmentally friendly process.

### BACKGROUND INFORMATION

A fuel cell, as presented in FIG. 1, includes an anode side 100 and a cathode side 102 and an electrolyte material 104 between them. In solid oxide fuel cells (SOFCs) oxygen can be fed to the cathode side 102 and can be reduced to a negative oxygen ion by receiving electrons from the cathode. The negative oxygen ion can go through the electrolyte material 104 to the anode side 100 where it can react with the used fuel producing water and also potentially carbondioxide (CO2). Between anode 100 and cathode 102 is an external electric circuit 111 comprising a load 110 for the fuel cell.

In FIG. 2 a SOFC device is presented as an example of a high temperature fuel cell device. A SOFC device can utilize as fuel for example natural gas, biogas, methanol or other compounds containing hydrocarbon mixtures. The SOFC device in FIG. 2 includes more than one (e.g., plural) fuel cells in stack formation 103 (SOFC stack). Each fuel cell comprises an anode 100 and a cathode 102 structure as presented in FIG. 1. Part of the used fuel can be recirculated in feedback arrangement 109 through each anode. The SOFC device in FIG. 2 also includes a fuel heat exchanger 105 and reformer 107. Heat exchangers can be used for controlling thermal conditions in fuel cell process and there can be more than one of them located in different locations of an SOFC device. The extra thermal energy in circulating gas can be recovered in one or more heat exchangers 105 to be utilized in SOFC device or outside heat recovering unit. Reformer 107 is a device that converts the fuel, such as for example natural gas, to a composition suitable for fuel cells, for example to a composition containing hydrogen and methane, carbondioxide, carbonmonoxide and inert gases. It is not necessary to have a reformer in each SOFC device.

By using measurement device 115 (such as a fuel flow meter, current meter and temperature meter) desired measurements can be carried out for the operation of the SOFC device from the anode through recirculating gas. Part of the gas used at anodes 100 can be recirculated through anodes in feedback arrangement 109 and the other part of the gas can be exhausted 114 from the anodes 100.

A solid oxide fuel cell (SOFC) device is an electrochemical conversion device that produces electricity directly from oxidizing a fuel. Advantages of an SOFC device can include high efficiencies, long term stability, low emissions, and cost. A disadvantage can be a high operating temperature which can result in long start up times and both mechanical and chemical compatibility issues.

Large solid oxide fuel cell systems can have many components, such as blowers, reactors, and heat exchangers, that are sized for nominal operation point. In the case of heat exchangers, the efficiency can be altered when the flow differs too much from the sizing values. In addition, in large systems the heat capacity of the components can be high, causing slow temperature level stabilization, which in turn affects the functioning of temperature-sensitive fuel cell system components, such as reformers and fuel cell stacks. These effects can cause the operation of a solid oxide fuel cell system in some other operation point than the nominal sizing point to be difficult, or at least causes a decrease in system efficiency. Different operating points may include variations in required power output, possible fluctuations in fuel quality as may occur, for example, in several biogases, and a desire to operate the SOFC system with some other fuel than the fuel the SOFC system was designed for. It would be desirable for so-called dual-fuel capability with reasonable efficiencies.

### SUMMARY

A high temperature fuel cell system is disclosed for producing electricity with fuel cells, each fuel cell having an anode side, a cathode side, and an electrolyte between the anode side and the cathode side, the fuel cell system comprising: at least one heat exchanger for arranging wanted temperature conditions in the fuel cell system; means for determining composition of a gas at the anode sides of the fuel cells by obtaining at least amounts of Oxygen (O) and Carbon (C) for providing as composition information at least a relationship between the amounts of Oxygen and Carbon (O/C relationship) in said gas; means for performing controlled gas recirculation at the anode sides by using said composition information as control information; means for performing controlled auxiliary water feed to the fuel cell system by using said composition information as control information; means for performing controlled gas feed into the fuel cell system by using said composition information as control information; ans means for controlling a rated power of the fuel cell system by controlling anode flow characteristics between said controlled gas recirculation at anode sides and said controlled auxiliary water feed, the means for controlling the rated power of the fuel cell system controlling said means for performing said controlled auxiliary water feed to the fuel cell system by using said composition information as control information based on detecting a change of the determined gas composition, controlling said means for performing controlled gas recirculation at anode sides by using said composition information as control information by changing said gas recirculation based on detecting a change of the determined gas composition, and controlling said means for performing controlled gas feed in to the fuel cell system by using said composition information as control information by changing said gas feed based on detecting a change of the determined gas composition, to change the rated power of the fuel cell system to control electricity production conditions for the gas used as fuel in the high temperature fuel cell system.

A method is disclosed for producing electricity in high temperature fuel cell system, in which method wanted temperature conditions are arranged for producing electricity with fuel cells, and an auxiliary water feed is arranged to the fuel cell system, the method comprising: recirculating gas used as fuel at anode sides of the fuel cells; determining a gas composition at the anode sides by obtaining at least amounts of Oxygen (O) and Carbon (C) for providing as composition information at least a relationship between the amounts of Oxygen and Carbon (O/C relationship) in said gas; controlling rated power of the fuel cell system by controlling anode flow characteristics between the gas recirculation at the anode sides and an auxiliary water feed; and controlling the rated power of the fuel cell system by performing controlled auxiliary water feed to the fuel cell system using said composition information as control information by changing said water feed based on detecting a change of the determined gas composition, by performing controlled gas recirculation at the anode sides using said composition information as control information by changing said gas recirculation based on detecting a change of the determined gas composition, and by performing controlled gas feed in to the fuel cell system using said composition information as control information by changing said gas feed based on detecting a change of the determined gas composition, to change the rated power of the fuel cell system to control electricity production conditions for the gas used as fuel in the high temperature fuel cell system.

### BRIEF DESCRIPTION OF THE DRAWINGS

FIG. 1 presents a known single fuel cell structure;

FIG. 2 presents an example of a known SOFC device; and

FIG. 3 presents an exemplary embodiment according to the present disclosure.

### DETAILED DESCRIPTION

A fuel cell system is disclosed that, in different situations with minimal changes in system configuration, can utilize gases that may have big differences in fuel composition, such as in percentage of methane.

This can be achieved by a high temperature fuel cell system for producing electricity with fuel cells, each fuel cell comprising an anode side, a cathode side, and an electrolyte between the anode side and the cathode side, and the fuel cell system comprising at least one heat exchanger for arranging wanted temperature conditions in the fuel cell system. The high temperature fuel cell system can include means for determining gas composition at the anode sides by obtaining at least amounts of Oxygen (O) and Carbon (C) for providing as composition information at least the relationship between the amounts of Oxygen and Carbon (O/C relationship) in said gas. Also included are means for performing controlled gas recirculation at anode sides by using said composition information as control information, and means for performing controlled auxiliary water feed to the fuel cell system by using said composition information as control information, means for performing controlled gas feed in to the fuel cell system by using said composition information as control information, means for controlling the rated power of the fuel cell system by controlling anode flow characteristics between said controlled gas recirculation at anode sides and said controlled auxiliary water feed.

The means for controlling the rated power of the fuel cell system can control said means for performing said controlled auxiliary water feed to the fuel cell system by using said composition information as control information by changing said water feed, when a desire for such change is detected on the basis of the determined gas composition, by controlling said means for performing controlled gas recirculation at anode sides by using said composition information as control information by changing said gas recirculation, when a need for such change is detected on the basis of the determined gas composition, and by controlling said means for performing controlled gas feed in to the fuel cell system by using said composition information as control information by changing said gas feed, when a desire for such change is detected on the basis of the determined gas composition, to change the rated power of the fuel cell system to keep electricity production conditions substantially optimal for the gas used as fuel in the high temperature fuel cell system.

Also disclosed herein is a method for producing electricity in high temperature fuel cell system, in which method wanted temperature conditions are arranged for producing electricity with fuel cells, and an auxiliary water feed can be arranged to the fuel cell system. In an exemplary method, gas used as fuel can be recirculated at the anode sides, and a gas composition at the anode sides can be determined by obtaining at least amounts of Oxygen (O) and Carbon (C) for providing as composition information at least the relationship between the amounts of Oxygen and Carbon (O/C relationship) in said gas. Controlling of the rated power can be accomplished by controlling anode flow characteristics between the gas recirculation at anode sides and the auxiliary water feed. The rated power of the fuel cell system can be controlled by performing controlled auxiliary water feed to the fuel cell system by using said composition information as control information by changing said water feed, when a desire for such change is detected on the basis of the determined gas composition, by performing controlled gas recirculation at the anode sides by using said composition information as control information by changing said gas recirculation, when a desire for such change is detected on the basis of the determined gas composition, and by performing controlled gas feed in to the fuel cell system by using said composition information as control information by changing said gas feed, when a desire for such change is detected on the basis of the determined gas composition, to change the rated power of the fuel cell system to keep electricity production conditions substantially optimal for the gas used as fuel in the high temperature fuel cell system.

Anode flow characteristics between an auxiliary water feed system and an anode gas recirculation system can be controlled by utilizing anode gas composition information by changing said auxiliary water feed, when such a desire arises, by changing said gas recirculation, when such a desire arises, and by changing gas feed in to fuel cell system, when such a desire arises, to change the rated power of the fuel cell system to ensure substantially optimal electricity production conditions even when the gas used in the fuel cell system is changed to a substantially different type of gas.

A benefit is that a nominal gas used in the high temperature fuel cell system can be changed with minimal changes in system configuration. This can be achieved even so that the same fuel device is used for gases that have very big differences in fuel composition such as in percentage of methane without a need to build up parallel fuel cell device for different gases.

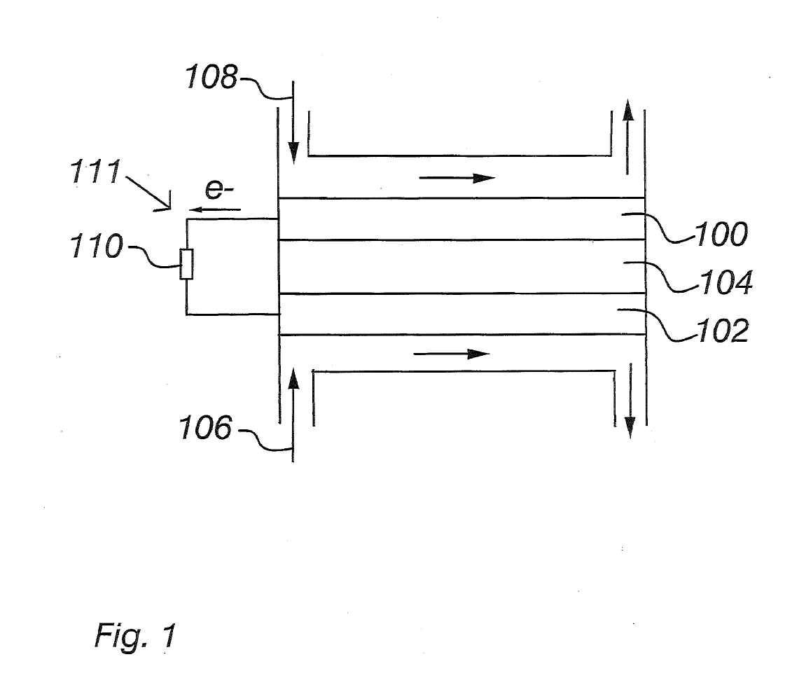

Solid oxide fuel cells (SOFCs) can have multiple geometries. The planar geometry (FIG. 1) is the known sandwich type geometry employed by many types of fuel cells, where the electrolyte 104 is sandwiched in between the electrodes, anode 100 and cathode 102. SOFCs can also be made in tubular geometries where, for example, either air or fuel is passed through the inside of the tube and the other gas is passed along the outside of the tube. This can be also arranged so that the gas used as fuel is passed through the inside of the tube and air is passed along the outside of the tube. The tubular design can be better in sealing air from the fuel. The performance of the planar design can be better than the performance of the tubular design however, because the planar design has a lower resistance comparatively. Other geometries of SOFCs include modified planar cells (MPC or MPSOFC), where a wave-like structure replaces the known flat configuration of the planar cell. Such designs are promising, because they can share the advantages of both planar cells (low resistance) and tubular cells.

The ceramics used in SOFCs do not become ionically active until they reach very high temperature and as a consequence of this the stacks may be heated at temperatures ranging from 600 to 1,000° C. Reduction of oxygen (FIG. 1) into oxygen ions occurs at the cathode 102. These ions can then be transferred through the solid oxide electrolyte 104 to the anode 100 where they can electrochemically oxidize the gas used as fuel. In this reaction, water and carbon dioxide byproducts are given off as well as two electrons. These electrons then flow through an external circuit 111 where they can be utilized. The cycle then repeats as those electrons enter the cathode material 102 again.

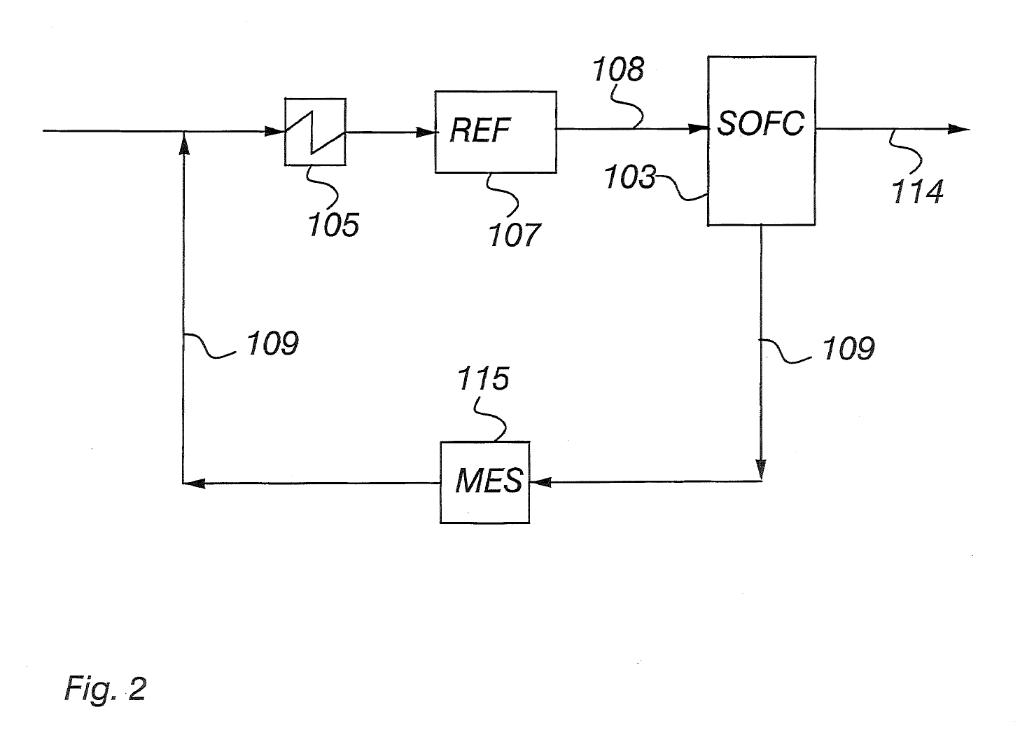

In large solid oxide fuel cell systems, exemplary fuels are natural gas (mainly methane), different biogases (mainly nitrogen and/or carbon dioxide diluted methane), and other higher hydrocarbon containing fuels, including alcohols. Methane and higher hydrocarbons can be reformed either in the reformer 107 (FIG. 2) before entering the fuel cell stacks or (partially) internally within the stacks 103. The reforming reactions use a certain amount of water, and additional water can also be used to prevent possible carbon formation (coking) caused by higher hydrocarbons. This water can be provided internally by circulating the anode gas exhaust flow, because water is produced in excess amounts in fuel cell reactions, and/or with an auxiliary water feed (e.g. direct fresh water feed or circulation of exhaust condensate). In the anode recirculation arrangement part of the unused fuel and dilutants in anode gas are also fed back to the process, whereas in auxiliary water feed arrangement, the only additive to the process is water.

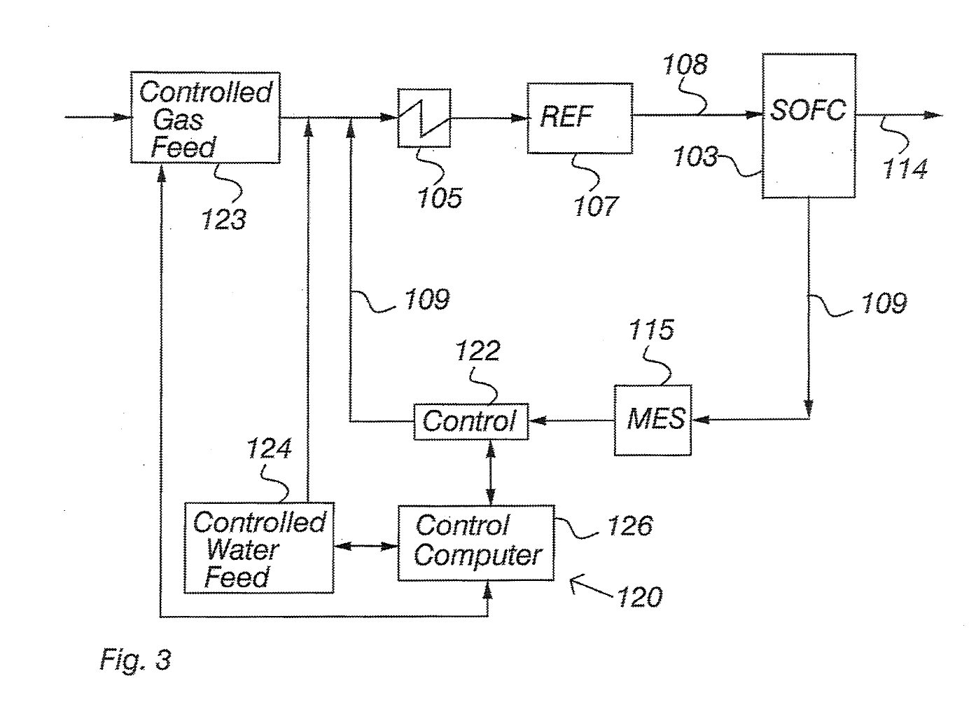

FIG. 3 presents an exemplary embodiment according to the present disclosure where the operation mode and ratios between anode recirculation and auxiliary water feed, the anode flow characteristics through gas processing reactors, heat exchangers and fuel cell stacks can be kept roughly constant while simultaneously providing adequate amounts of water for reforming reactions and preventing coking. This exemplary solid oxide fuel cell system includes means 120 (e.g., a dedicated or general processor with memory) for determining a gas composition at anode sides 100 for providing a composition information. In this exemplary embodiment of the disclosure, this composition information is the relationship between oxygen and carbon (i.e., O/C relationship), in said gas used as fuel. Composition information may also comprise water volume information and/or the relationship between hydrogen and carbon (i.e., H/C relationship). Both the O/C relationship and/or water volume information and/or the H/C relationship are, for example, determined by a calculating process and thus said means 120 for determining a gas composition are, for example, a calculating processor located in a computer 126 or in some other device. Of course the means 120 may also be, or include, measurement equipment to measure desired values from the gas flow.

This solid oxide fuel cell system (FIG. 3) according to an exemplary embodiment of the disclosure can include at least one heat exchanger 105 for arranging wanted temperature conditions in the fuel cell system. The composition information can be also utilized for the heat exchanger by using a passing arrangement for directing the operation of the said at least one heat exchanger. The efficiency of the said at least one heat exchanger may even be controllable by using said passing arrangement that utilizes composition information. This passing arrangement can include one or more pipe(s) passing direct steam flow or anode recirculation feed or combination of these.

The composition information can be utilized by the means 122 for performing controlled gas recirculation at anode sides 100 by changing the amount and/or temperature of the gas. The composition information can also be utilized by means 124 for performing controlled auxiliary water feed to the fuel cell system by changing the amount and/or temperature of the water. The embodiments according to the disclosure can also include means 123 for performing controlled gas feed in to the fuel cell system by utilizing said composition information by changing the amount and/or temperature of the gas. These means 122, 123, 124 for controlling can, for example, be one or more control processor(s) located for example in the same control computer 126 or separately as FIG. 3 presents with dedicated processor means 122, 123, 124.

When the gas used as fuel is exchanged, for example from natural gas to bio gas, the rated power of the fuel cell system can be changed to keep electricity production conditions substantially optimal for the gas used as fuel in the solid oxide fuel cell system. This can be accomplished by means 126 for controlling the rated power of the solid oxide fuel cell system by controlling said means 124 for performing controlled auxiliary water feed to the fuel cell system by utilizing said composition information as described, by controlling said means 122 for performing controlled gas recirculation at anode sides 100 by utilizing said composition information as described and by controlling said means 123 for performing controlled gas feed in to the fuel cell system by utilizing said composition information as described. The means 126 for controlling the rated power of the solid oxide fuel cell system can, for example, include one or more control processor(s) located for example in the control computer 126 as presented in FIG. 3. Though means 126 can be a computer, the disclosure can be accomplished with means 126 comprising for example a control logic circuit or equivalent.

In an exemplary embodiment of the disclosure, controlling of the rated power with controlling means 126 can be accomplished by controlling the anode flow characteristics between gas recirculation at anode sides and auxiliary water feed by using said means 120 for determining gas composition and by using said controlling means 122 and/or 123 and/or 124 as described. As shown with two-directional arrows in FIG. 3, there can be two-directional control information flows between controlling means 122, 123, 124 and 126 for example to provide feedback information to controlling means 126 so that the described controlling arrangement according to the disclosure actively follows the state of the control process in the fuel cell system.

In addition to the SOFCs, the present disclosure can also be utilized with, for example, MCFCs (Molten Carbonate Fuel Cells) and other high temperature fuel cells that operate at 400° C. and higher temperatures. MCFCs are high-temperature fuel cells that use an electrolyte composed of a molten carbonate salt mixture suspended in a porous, chemically inert ceramic matrix of BASE, Beta-Alumina Solid Electrolyte.

Exemplary embodiments of the present disclosure can allow the same SOFCs (or MCFCs or other) system parts and components to be used successfully in a dual-fuel (eg. natural gas, bio gas) operation system. The system can be on/off type that comprises a switch to select an operation mode according to the gas that is to be used. In an exemplary embodiment of the disclosure (FIG. 3), the system can, for example, be an automatic control system that changes its operation mode following the changes in gas composition as described. The methane content in used gas can be allowed to vary between almost 100% (natural gas) to even such low as 30% or lower (“dirty” biogas). In an exemplary embodiment of the disclosure, many, or even all, of the SOFC system parts and components are common for different gas types used as fuel. If it is reasonable, the disclosure can also be utilized so that only few of the SOFC system parts and components are common for different gas types used as fuel.

Features according to exemplary embodiments of the disclosure may be important when using diluted biogas as fuel, because the known anode recirculation could cause inerts to be built-up into the loop causing extremely high anode recirculation flows to provide an inadequate amount of water. This could cause the gas processing components and parts to be over-dimensioned when changed from a biogas application to a natural gas application according to known methods. By changing the ratio between anode recirculation and auxiliary water feed according to the disclosure, the same system parts and components can be used in different gases operation and the system power and especially efficiency remain in good or at least reasonable values.

The disclosure applies similarly for possible needs to control the power output, and hence in controlling the required inlet fuel flow to maintain high efficiency. The disclosure applies similarly also for possible fluctuations in fuel quality, which is the case for example in known biogas applications. In known systems with high fluctuation there can be a high safety margin to prevent coking. When indirect or direct on-line measurement of the fuel composition is applied according to exemplary embodiments of the disclosure to control a specified water amount while still maintaining substantially constant flow characteristics at the anode sides, even considerably low safety margins can be enough to prevent coking.

Although the disclosure has been presented in reference to the attached figures and specification, the disclosure is by no means limited to those as the disclosure is subject to variations within the scope allowed for by the claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A high temperature fuel cell system for producing electricity with fuel cells, each fuel cell having an anode side, a cathode side, and an electrolyte between the anode side and the cathode side, the fuel cell system comprising:
at least one heat exchanger for arranging wanted temperature conditions in the fuel cell system;
means for determining composition of a gas at the anode sides of the fuel cells by obtaining at least amounts of Oxygen (O) and Carbon (C) for providing as composition information at least a relationship between the amounts of Oxygen and Carbon (O/C relationship) in said gas;
means for performing controlled gas recirculation at the anode sides by using said composition information as control information;
means for performing controlled auxiliary water feed to the fuel cell system by using said composition information as control information;
means for performing controlled gas feed into the fuel cell system by using said composition information as control information; and
means for controlling a rated power of the fuel cell system by controlling anode flow characteristics between said controlled gas recirculation at the anode sides and said controlled auxiliary water feed, the means for controlling the rated power of the fuel cell system controlling said means for performing said controlled auxiliary water feed to the fuel cell system by using said composition information as control information based on detecting a change of the determined gas composition, controlling said means for performing controlled gas recirculation at the anode sides by using said composition information as control information by changing said gas recirculation based on detecting a change of the determined gas composition, and controlling said means for performing controlled gas feed in to the fuel cell system by using said composition information as control information by changing said gas feed based on detecting a change of the determined gas composition, to change the rated power of the fuel cell system to control electricity production conditions for the gas used as fuel in the high temperature fuel cell system.

2. A high temperature fuel cell system in accordance with claim 1, wherein the fuel cell system comprises;
means for performing controlled auxiliary water feed by changing the amount and/or temperature of the water based on said composition information.

3. A high temperature fuel cell system in accordance with claim 1, wherein the fuel cell system comprises:
means for performing controlled gas recirculation by changing the amount and/or temperature of the gas based on said composition information.

4. A high temperature fuel cell system in accordance with claim 1, wherein the fuel cell system comprises:
a bypassing arrangement for directing operation of the at least one heat exchanger based on said composition information.

5. A high temperature fuel cell system in accordance with claim 1, wherein the fuel cell system comprises:
a bypassing arrangement for controlling efficiency of the said at least one heat exchanger based on said composition information.

6. A high temperature fuel cell system in accordance with claim 1, wherein the fuel cell system comprises:
means for changing a ratio between anode recirculation and auxiliary water feed using substantially the same system parts and components in operating with different gases.

7. A high temperature fuel cell system in accordance with claim 1, in combination with the fuel cells.

8. A method for producing electricity in high temperature fuel cell system, in which method wanted temperature conditions are arranged for producing electricity with fuel cells, and an auxiliary water feed is arranged to the fuel cell system, the method comprising:
recirculating gas used as fuel at anode sides of the fuel cells;
determining a gas composition at the anode sides by obtaining at least amounts of Oxygen (O) and Carbon (C) for providing as composition information at least a relationship between the amounts of Oxygen and Carbon (O/C relationship) in said gas;
controlling rated power of the fuel cell system by controlling anode flow characteristics between the gas recirculation at the anode sides and an auxiliary water feed; and
controlling the rated power of the fuel cell system by performing controlled auxiliary water feed to the fuel cell system using said composition information as control information by changing said water feed based on detecting a change of the determined gas composition, by performing controlled gas recirculation at the anode sides using said composition information as control information by changing said gas recirculation based on detecting a change of the determined gas composition, and by performing controlled gas feed in to the fuel cell system using said composition information as control information by changing said gas feed based on detecting a change of the determined gas composition, to change the rated power of the fuel cell system to control electricity production conditions for the gas used as fuel in the high temperature fuel cell system.

9. A method in accordance with claim 8, wherein said water feed is changed by changing the amount and/or temperature of the water based on said composition information.

10. A method in accordance with claim 8, wherein said gas recirculation is changed by changing the amount and/or temperature of the gas based on said composition information.

11. A method in accordance with claim 8, comprising:
directing the operation in arranging wanted temperature conditions with a bypassing arrangement based on said composition information.

12. A method in accordance with claim 8, comprising:
controlling an efficiency in arranging wanted temperature conditions with a bypassing arrangement based on said composition information.

13. A method in accordance with claim 8, wherein a ratio between anode recirculation and an auxiliary water feed is changed for using substantially the same system parts and components in operating with different gases.
